(19) United States
(12) Patent Application Publication
(10) Pub. No.: US 2022/0258796 A1
(43) Pub. Date: Aug. 18, 2022

(54) CONTROL DEVICE, AND CONTROL METHOD FOR CONTROLLING ELECTRIC POWER STEERING DEVICE

(71) Applicant: HONDA MOTOR CO., LTD., Tokyo (JP)

(72) Inventors: Akira Shiogai, Tokyo (JP); Masaya Kusatani, Tokyo (JP)

(21) Appl. No.: 17/665,710

(22) Filed: Feb. 7, 2022

(30) Foreign Application Priority Data
Feb. 15, 2021 (JP) 2021-021676

(51) Int. Cl. B62D 6/08; B62D 5/04

(52) U.S. Cl. CPC B62D 6/08; B62D 5/0421; B62D 5/0481

(57) ABSTRACT

A control device controlling an electric power steering device that includes a motor generating a steering torque and applies a steering force to a steering mechanism of a vehicle, the control device including a control unit that receives a specific signal which indicates a requested value relating to an operation of the motor and which contains a specific type of requested value and an attribute of the requested value, and controls the motor based on the requested value indicated by the received specific signal.

### INCORPORATION BY REFERENCE

The present application claims priority under 35 U.S.C. § 119 to Japanese Patent Application No. 2021-021676 filed on Feb. 15, 2021. The content of the application is incorporated herein by reference in its entirety.

### BACKGROUND OF THE INVENTION

### Field of the Invention

The present invention relates to a control device and a control method for controlling an electric power steering device.

### Description of the Related Art

Electric power steering devices for vehicles are required to have high reliability and various steering performances. Therefore, in the development of the electric power steering devices, an increase in design man-hours has become an issue, and improvement in design efficiency is desired. For example, Japanese Patent Laid-Open No. 2008-269080 discloses a device that supports the design of a control device controlling an electric power steering device. The design support device of Japanese Patent Laid-Open No. 2008-269080 includes a table that divides a program of the control device into a plurality of control modules for respective control functions and associates the control modules with design parameters and a classification of required specifications. It is therefore said that the required specifications can be efficiently reflected in the progress of the design of the electric power steering device from an upstream step to a downstream step.

However, the specifications of the electric power steering device may be significantly changed, such as when a new function of the vehicle is proposed. In such a case, it is difficult to improve the design efficiency; thus, reduction of the design man-hours is desired.

The present invention has been made in view of such background, and an object of the present invention is to reduce design man-hours associated with control of an electric power steering device.

### SUMMARY OF THE INVENTION

A first aspect for achieving the foregoing object is a control device controlling an electric power steering device that includes a motor generating a steering torque and applies a steering force to a steering mechanism of a vehicle, the control device including a control unit that receives a specific signal which indicates a requested value relating to an operation of the motor and which contains a specific type of requested value and an attribute of the requested value, and controls the motor based on the requested value indicated by the received specific signal.

The electric power steering device described above may include an arbitration unit that receives a request signal transmitted by a device outside the control device, wherein the arbitration unit generates the specific signal by arbitrating the request signal transmitted by the device outside the control device, and transmits the generated specific signal to the control unit.

The electric power steering device described above may be configured to receive the request signal that is arbitrated and transmitted by the device outside the control device.

The electric power steering device described above may be configured to include priority designation information for defining a priority of the specific signal, and the control unit may be configured to control the motor based on the requested value indicated by the specific signal, in accordance with the priority defined by the priority designation information.

In the electric power steering device described above, the priority designation information may be information associating the attribute of the requested value indicated by the specific signal, with a priority of processing of the requested value indicated by the specific signal, and the control unit may be configured to control the motor based on the requested value indicated by the specific signal, in accordance with the priority defined by the priority designation information.

In the electric power steering device described above, the attribute of the requested value indicated by the specific signal may include at least one of a type of the requested value indicated by the specific signal and a functional safety level of the requested value indicated by the specific signal.

In the electric power steering device described above, the attribute of the requested value indicated by the specific signal may include a functional safety level of the requested value indicated by the specific signal, and the priority designation information may be information that is defined in such a manner that, for the specific signals having different functional safety levels, processing based on the specific signal having a higher functional safety level may be executed preferentially, and, for the specific signals having an identical functional safety level, processing based on the specific signal having a larger requested value may be executed preferentially.

In the electric power steering device described above, the steering mechanism may be configured to include a steering handle, and the requested value included in the specific signal may be a value indicating an additional torque added to an operation amount of the steering handle when the motor is operated according to the operation amount of the steering handle.

A second aspect for achieving the foregoing object is a control method for controlling an electric power steering device that includes a motor generating a steering torque and applies a steering force to a steering mechanism of a vehicle, the control method including a step of inputting, to a control device controlling the motor, a specific signal which indicates a requested value relating to an operation of the motor and which contains a specific type of requested value and an attribute of the requested value, and a step of causing the control device to control the motor based on the requested value indicated by the specific signal.

### Advantageous Effect of Invention

According to the configurations described above, even in a case where design changes occur in relation to the operation of the electric power steering device, such changes can be made without significantly changing the specifications of the control device. Thus, design man-hours associated with the control of the electric power steering device can be reduced.

### BRIEF DESCRIPTION OF THE DRAWINGS

FIG. 1 shows a schematic configuration diagram of an electric power steering device;

FIG. 2 shows a diagram illustrating a configuration of a control device;

FIG. 3 shows an explanatory diagram illustrating an example of processing by the control device;

FIG. 4 shows a schematic view illustrating an example of a priority map;

FIG. 5 shows a flowchart illustrating an operation of the control device; and

FIG. 6 shows a flowchart illustrating an operation of the control device.

### DETAILED DESCRIPTION OF THE PREFERRED EMBODIMENTS

### 1. Configuration of Electric Power Steering Device

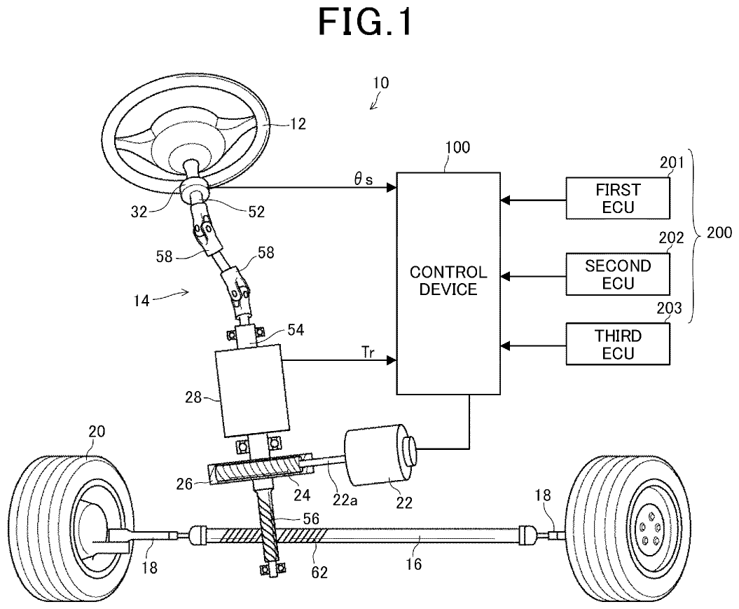

FIG. 1 shows a schematic configuration diagram of an electric power steering device 10 according to an embodiment. FIG. 1 also illustrates a device associated with control of the electric power steering device 10.

The electric power steering device 10 is a device mounted on a vehicle to steer the vehicle. For example, the electric power steering device 10 is mounted on a four-wheeled vehicle. The electric power steering device 10 includes a steering handle 12 (steering wheel) operated by a driver of the vehicle.

The vehicle equipped with the electric power steering device 10 generates a steering torque by a motor 22 described hereinafter in response to an operation of the steering handle 12, and assists the driver in steering. Also, the vehicle has a function of using the electric power steering device 10 to steer the steering handle 12 in excess of an operation amount thereof and to perform an operation that does not correspond to the operation of the steering handle 12.

The electric power steering device 10 includes the steering handle 12, a steering shaft 14, a rack shaft 16, a tie rod 18, and left and right front wheels 20 as turning wheels. The steering shaft 14, the rack shaft 16, and the tie rod 18 constitute a manual steering system.

The manual steering system directly transmits a steering operation of the steering handle 12 operated by the driver to the front wheels 20. The steering shaft 14 includes a main steering shaft 52 integrally joined to the steering handle 12, a pinion shaft 54 provided with a pinion 56 of a rack and pinion mechanism, and a universal joint 58 that couples the main steering shaft 52 and the pinion shaft 54. The pinion 56 meshes with rack teeth 62 of the rack shaft 16 capable of reciprocating in a vehicle width direction.

A rotational force generated by the steering handle 12 operated by the driver, that is, a steering torque Tr, is transmitted to the pinion shaft 54 via the main steering shaft 52 and the universal joint 58. The steering torque Tr is converted into a thrust by the pinion 56 of the pinion shaft 54 and the rack teeth 62 of the rack shaft 16, and the thrust displaces the rack shaft 16 in the vehicle width direction. The tie rod 18 turns the front wheels 20 in response to the displacement of the rack shaft 16, changing the direction of the vehicle.

The electric power steering device 10 includes the motor 22, a worm gear 24, a worm wheel gear 26, a torque sensor 28, a steering angle sensor 32, and a control device 100.

The motor 22, the worm gear 24, and the worm wheel gear 26 constitute an assist drive system. The assist drive system generates a steering assist force for assisting the driver in steering and steering on behalf of the driver. An output shaft 22a of the motor 22 is coupled to the worm gear 24 and further coupled to the rack shaft 16 via the worm wheel gear 26. The worm wheel gear 26 meshing with the worm gear 24 is formed on the pinion shaft 54, and the pinion shaft 54 is coupled to the rack shaft 16.

The torque sensor 28, the steering angle sensor 32, and the control device 100 constitute an assist control system. The assist control system controls the assist drive system. The motor 22 is, for example, a three-phase AC brushless motor. According to the control by the control device 100, electric power is supplied from an inverter, not shown, to the motor 22, and the motor 22 generates a driving force according to the supplied electric power. The driving force of the motor 22 is transmitted to the rack shaft 16 via the output shaft 22a, the worm gear 24, and the pinion shaft 54 to steer the vehicle.

The torque sensor 28 detects the steering torque Tr of the electric power steering device 10 and outputs the detected value to the control device 100. As shown in FIG. 1, for example, the torque sensor 28 is provided on the pinion shaft 54 and detects the steering torque Tr based on a change in magnetic characteristics caused by magnetic strain. The steering angle sensor 32 detects a steering angle θs of the electric power steering device 10 and outputs the steering angle θs to the control device 100.

The control device 100 executes steering assist control based on the values of the steering angle θs detected by the steering angle sensor 32 and the steering torque Tr detected by the torque sensor 28. In the steering assist control, the control device 100 runs the motor 22 according to the operation amount of the steering handle 12, to generate an assist torque. Steering assist control enables the driver to operate the steering handle 12 with a light force. In the steering assist control, the control device 100 turns the front wheels 20 in accordance with the operation amount of the steering handle 12.

Furthermore, a host control unit 200 is connected to the control device 100. The number of host control units 200 connected to the control device 100 is not limited. Thus, needless to say, a configuration is possible in which a plurality of the host control units 200 are connected to the control device 100. FIG. 1 illustrates a configuration in which a first host control unit 201, a second host control unit 202, and a third host control unit 203 are connected as the host control units 200 to the control device 100.

The host control unit 200 is a device that controls the posture of the vehicle, and is composed of a single ECU (Electronic Control Unit) or a plurality of devices including the ECUs. The host control unit 200 requests the control device 100 to steer the front wheels 20, the steering not corresponding to the operation amount of the steering handle 12. The ECU includes a microcontroller or a processor composed of a CPU (Central Processing Unit). The ECU may include a memory for storing data and programs processed by the processor, a transceiver circuit for transmitting and receiving signals, and the like.

The host control unit 200 and the control device 100 are connected by, for example, a CAN (Controller Area Network) bus. In this configuration, the host control unit 200 may be able to send a signal to the control device 100 through the CAN bus, and is not limited to having a configuration in which the control device 100 and the host control unit 200 are directly connected one-to-one.

The host control unit 200 is, for example, a device constituting an advanced driver-assistance system (ADAS).

Examples of a function of the host control unit 200 include a steering assist function of adding a steering angle to the steering of the steering handle 12 performed by the driver. More specifically, the host control unit 200 is a system that includes a road departure mitigation (RDM) function of steering the vehicle so that the vehicle does not deviate from the lane of the road while running, a straight driving assist (SDA) function of assisting the vehicle in traveling straight, and/or a motion adaptive function of stabilizing the posture of the running vehicle. The host control unit 200 may be a system that steers without an operation of the steering handle 12. Specifically, such a system may include an automatic lane change (ALC) function of automatically executing a lane change operation, a lane keep assistance (LKA) function of causing the vehicle to keep running near the center of the lane, and/or an automatic drive (AD) function of automatically accelerating/decelerating and steering the vehicle. The AD function is, for example, a function of controlling the vehicle in a so-called hands-off state in which the driver releases his/her hands from the steering handle 12. Furthermore, the AD function may be a function of controlling the vehicle on condition that the driver is touching the steering handle 12 in a so-called hands-on state. Examples of the functions of the host control unit 200 also include an automatic parking system (APS) for moving the vehicle to a predetermined parking spot. Examples of the functions of the host control unit 200 further include an automatic emergency steering (AES) function of steering for the purpose of avoiding a collision, and a side collision mitigation (SCM) function. Examples of the functions of the host control unit 200 also include a medical emergency stop (MES) function of detecting the physical condition of the driver and urgently stopping the vehicle, and a driver attention monitor (DAM) function of monitoring the condition of the driver and steering the vehicle for the purpose of giving a warning to the driver.

The host control unit 200 is configured as, for example, a device having one or more of the functions listed above. The first host control unit 201, the second host control unit 202, and the third host control unit 203 illustrated in FIG. 1 are each an ECU having the above-mentioned one or more functions, and each transmit signals S1, S2, and S3 relating to said function(s), respectively. The signals S1, S2, and S3 are signals requesting for steering by the electric power steering device 10. The control device 100 controls the motor 22 and steers based on the signals S1, S2, and S3. The signals S1, S2, and S3 correspond to an example of the request signal.

### 2. Configuration of Control Device

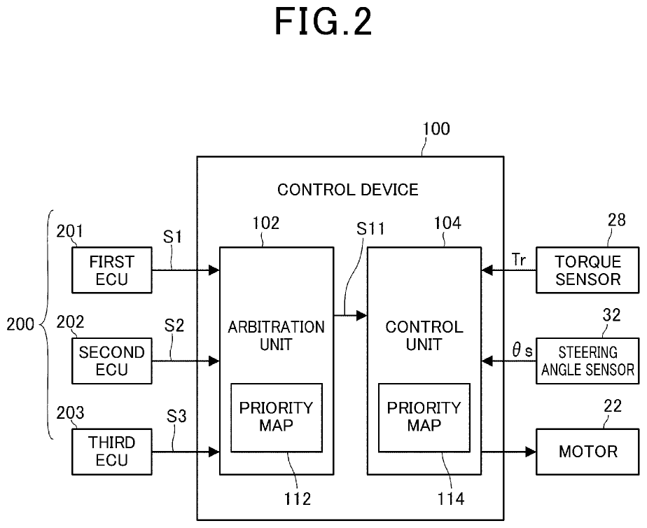

FIG. 2 shows a diagram illustrating a configuration of the control device 100.

The control device 100 includes an arbitration unit 102 and a control unit 104. The arbitration unit 102 and the control unit 104 may each be configured by an independent ECU, or the control device 100 may be configured by an ECU in which the arbitration unit 102 and the control unit 104 are integrated.

The signals S1, S2, and S3 are input to the arbitration unit 102. The arbitration unit 102 includes a priority map 112. The priority map 112 includes information defining the priority of an execution order in which the signals S1, S2, and S3 are executed. The priority map 112 corresponds to an example of the priority designation information. The arbitration unit 102 executes arbitration of the signals S1, S2, and S3 in accordance with the priority map 112, and transmits an arbitrated specific signal S11 to the control unit 104.

The control unit 104 executes processing instructed by the specific signal S11, based on the steering torque Tr input from the torque sensor 28 and the steering angle θs input from the steering angle sensor 32, and controls the motor 22. The control unit 104 does not have to be connected directly to the motor 22. For example, the control unit 104 may be configured to control the inverter, not shown, that supplies electric power to the motor 22.

The control unit 104 includes a priority map 114. The priority map 114 includes information defining the priority of an execution order in which the specific signal S11 is executed. The priority map 114 may include the same information as the priority map 112, or may have different information. In a case where requests indicated by the specific signal S11 conflict with each other, the control unit 104 executes processing corresponding to the requests in accordance with the priority defined by the priority map 114.

### 3. Operations of Control Device

The details of the operations of the control device 100 are now described with reference to specific examples.

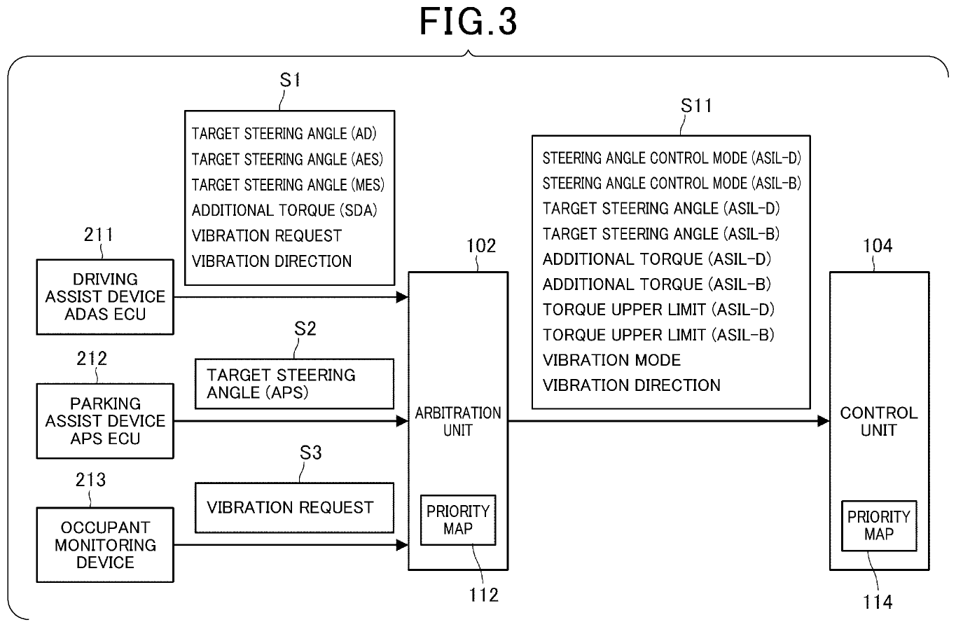

FIG. 3 shows an explanatory diagram illustrating an example of processing by the control device 100.

FIG. 3 illustrates a driving assist device 211 as a specific example of the first host control unit 201, a parking assist device 212 as a specific example of the second host control unit 202, and an occupant monitoring device 213 as a specific example of the third host control unit 203.

The signals S1, S2, and S3 transmitted by the driving assist device 211, the parking assist device 212, and the occupant monitoring device 213 each include a requested value and an attribute of the requested value. The attribute of the requested value includes, for example, the type of the requested value and the function associated with the request.

The driving assist device 211 has the AD function, the AES function, the MES function, and the SDA function in the hands-off state. In this configuration, the types of the requested values included in the signal S1 are a target steering angle, a vibration request, a vibration direction, and an additional torque. The requested values indicate an operation amount of the electric power steering device 10 for which the driving assist device 211 request the control device 100. The target steering angle is an angle steered by the motor 22, and is a steering angle detected by the steering angle sensor 32. For example, the requested value “target steering angle (AD)” refers to a value of the steering angle designated by the AD function, and is a signal for requesting the control unit 104 to drive the motor 22 with this value as the target.

Similarly, “target steering angle (AES)” included in the signal S1 is a requested value required by the AES function, and “target steering angle (MES)” is a requested value required by the MES function. “Additional torque (SDA)” is a requested value of the SDA function.

The attributes of the requested values of the signal S1 include information indicating that the types of the requested values are each the target steering angle, the additional torque, the vibration request, or the vibration direction. Additionally, the attributes of the requested values of the signal S1 are information indicating that the function associated with the requested value is the AD function, the AES function, the MES function, or the SDA function.

Vibration is a function of generating vibration in the steering handle 12 by intermittently switching a rotation direction of the output shaft 22a by means of the motor 22. For example, in a case where the driving assist device 211 determines using a driver monitor function that the driver is not focused on driving, the driving assist device 211 transmits the signal S1 requesting for vibration. The vibration request is a control signal that requests the control unit 104 to execute a vibration function. The vibration direction refers to a requested value that designates the direction in which the output shaft 22a is moved at the start of the vibration function, and CW (clockwise) or CCW (counterclockwise) is designated as the rotation direction of the steering handle 12 as seen from the driver. The control unit 104 may be capable of generating vibrations of a plurality of types of patterns by means of the motor 22. In this case, the signals S1, S2, and S3 may each include a requested value that designates a vibration pattern.

The driving assist device 211 transmits the signal S1 at the timing required by each of the AD function, the AES function, and the MES function. Therefore, the timing at which the driving assist device 211 transmits the signal S1 and the type of the request included in the signal S1 differ depending on the state of execution of the function of the driving assist device 211.

The parking assist device 212 is the automatic parking system (APS). The parking assist device 212 requests the control device 100 to steer in processing for parking the vehicle at a designated parking spot, and designates the target steering angle. The signal S2 includes a “target steering angle (APS)” as a requested value of APS. The function of the automatic parking system of the present embodiment is executed on condition that the driver does not touch the steering handle 12. The attribute of the requested value refers to information indicating that the type of the requested value is the target steering angle and information indicating that the function associated with the requested value is the APS function.

The occupant monitoring device 213 has the driver monitor (DAM) function. The occupant monitoring device 213 transmits a vibration request and a vibration direction as the signal S3 when notification to the driver is necessary. The attribute of the requested value refers to information indicating that the type of the requested value is the vibration request or the vibration direction. The signal S3 may include information indicating that the function associated with the requested value is the DAM function as the attribute of the requested value, but the description thereof is omitted herein.

The arbitration unit 102 performs arbitration processing on the signals S1, S2, and S3. The arbitration processing is for resolving a conflict in a case where a conflicting request is made to the control device 100 by the host control unit 200. Specifically, the conflict refers to (1) a request made for the same type of control as the control of the motor 22 being executed by the control device 100 according to any one of the signals S1, S2, and S3, and (2) a request made for the same type of control as the control to be executed, before the control device 100 starts such control of the motor 22 according to any of the signals S1, S2, and S3. The same signals may conflict, that is, for example, the signal S1 transmitted first by the driving assist device 211 and the signal S1 transmitted subsequently may conflict.

The arbitration unit 102 converts the signals S1, S2, and S3 into a standardized specific signal S11 that can be received by the control unit 104. In the present embodiment, the specific signal S11 includes a requested value, the type of the requested value, and the functional safety level of the requested value. The type of the requested value and the functional safety level of the requested value are examples of attributes of the requested value. The functional safety level can also be referred to as a safety requirement level. Specific examples of functional safety levels include SIL (Safety Integrity Level) defined by IEC 61508 and ASIL (Automotive Safety Integrity Level) defined by ISO 26262. The present embodiment describes an example adopting ASIL. The specific signal S11 of the present embodiment includes a requested value, the type of the requested value, and ASIL-A, ASIL-B, ASIL-C, and ASIL-D, which are ranks of ASIL of the requested value. The specific signal S11 is a signal that includes the type of the requested value and the attribute of the requested value in a specific aspect.

When the signals S1, S2, and S3 conflict with each other, the arbitration unit 102 determines the priority based on the attribute of the requested value indicated by the conflicting signals. The attribute of the requested value used in determination of the priority includes the degree of robustness of the requested value. The degree of robustness can refer to the reliability of the requested value, and examples include the functional safety level. In the present embodiment, the ASIL rank is used as the attribute of the degree of robustness. The arbitration unit 102 assigns an ASIL rank that corresponds to the information indicating the function associated with the requested value among the attributes of the requested values included in the signals S1, S2, and S3. For example, the ASIL-D is associated with functions executed hands-off such as AD and APS, the AES function, and the MES function, the ASIL-B is associated with a hands-on function, and the vibration request and the vibration direction are not subject to ASIL.

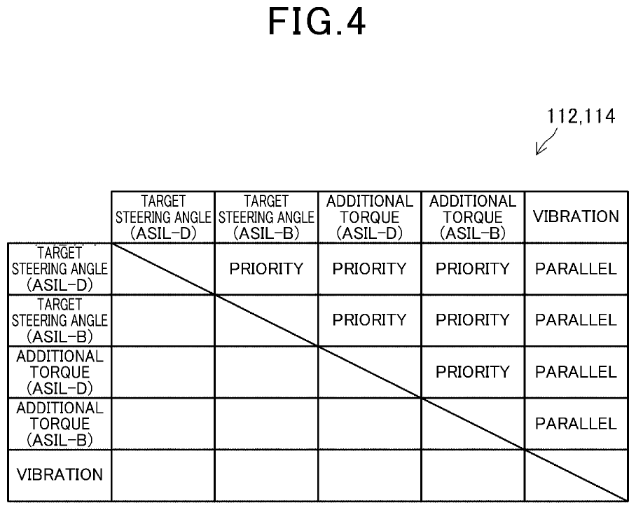

FIG. 4 shows a schematic view illustrating an example of the priority map 112.

The priority map 112 defines the priority of the requested value based on the type of the requested value and the ASIL rank of the requested value. The priority map 112 illustrated in FIG. 4 takes a form in which a prioritized requested value is designated when two requested values are compared, and for example, the priority map may be information for determining a priority order for three or more requested values. The priority map 112 determines that the requested value on the higher ASIL rank side has priority for the requested value of the same type. Additionally, the priority map 112 determines that the priority becomes low in the order of the target steering angle, the additional torque, and the vibration, with respect to the type of the requested value. For example, the target steering angle takes precedence over the additional torque regardless of the ASIL rank. For the same type of requested value, the requested value of ASIL-D takes precedence over the requested value of ASIL-B. The vibration can be executed in parallel with the operation of the control unit 104 based on the requested value of the target steering angle and the operation of the control unit 104 based on the requested value of the additional torque.

The priority of the priority map 112 is not limited to the one described above. For example, the basic priority can be set as described above, and an exception can be provided. Specifically, in the priority map 112, the requested value of the additional torque of ASIL-D can be set to have a higher priority than the target steering angle of ASIL-B. As described above, in the present embodiment, since the priority of the requested value is determined using the priority map 112, the priority that does not conform to the basic priority rule can be set as well. The same applies to the priority map 114.

Of course, as a rule for determining the priority, priority can be given to the ASIL rank over the type of the requested value.

Here, as the degree of robustness of the requested value, the degree of robustness of a communication path through which the requested value is input to the control device 100 may be used. For example, in a case where the host control unit 200 and the control device 100 are connected by the CAN bus, the priority of the requested value transmitted to the control device 100 through the communication path using a message authentication code (MAC) may be set to be higher than the requested value transmitted without using MAC.

Moreover, in the present embodiment, the priority map 114 of the control unit 104 is the same information as the priority map 112.

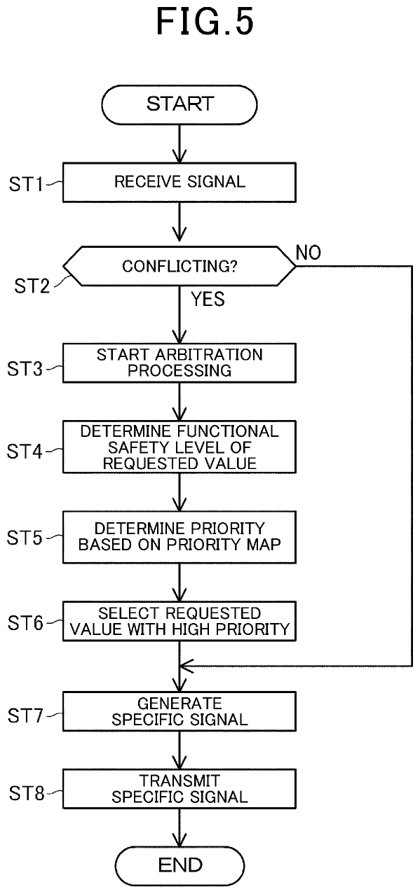

FIG. 5 shows a flowchart illustrating an operation of the control device 100, and particularly illustrates an operation of the arbitration unit 102.

The arbitration unit 102 receives a signal from the host control unit 200 (step ST1) and determines whether or not the received signal conflicts with another signal (step ST2). In step ST2, for example, it is determined whether or not the requested value of the signal received in step ST1 and the requested value of the signal received prior to step ST1 conflict with each other. Also, in a case where a plurality of signals are received with a short time difference in step ST1, the arbitration unit 102 determines whether or not the requested values of the plurality of signals conflict with each other.

In a case where it is determined that the requested values of the plurality of signals conflict with each other (step ST2; YES), the arbitration unit 102 starts arbitration processing (step ST3). In the arbitration processing, the arbitration unit 102 determines the functional safety levels of the requested values indicated by the conflicting signals (step ST4). Based on the types and the functional safety levels of the conflicting requested values, the arbitration unit 102 determines the priority according to the priority map 112 (step ST5). The arbitration unit 102 selects the requested value having a high priority (step ST6).

The arbitration unit 102 generates the specific signal S11 that includes the selected requested value, the type of the selected requested value, and the functional safety level determined in step ST4 (step ST7), and transmits the specific signal S11 to the control unit 104 (step ST8).

Further, in a case where it is determined that the signals received in step ST1 do not conflict (step ST2; NO), the arbitration unit 102 proceeds to step ST7 and executes processing.

The control unit 104 controls the motor 22 based on the specific signal S11 transmitted by the arbitration unit 102. The control unit 104 also has a function of performing arbitration based on the priority map 114 in a case where a conflict of the specific signal S11 occurs.

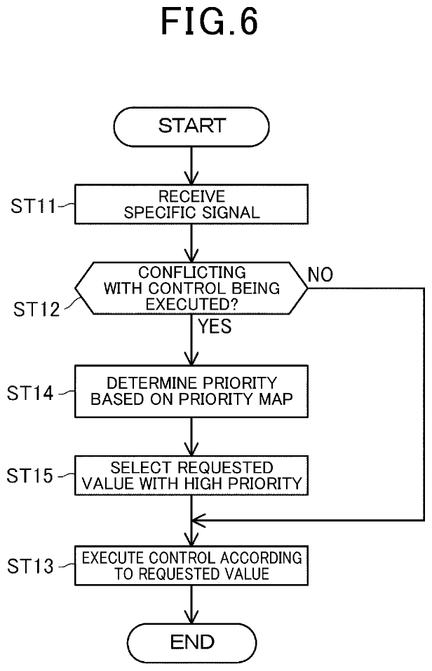

FIG. 6 shows a flowchart illustrating an operation of the control device 100, and particularly illustrates an operation of the control unit 104.

The control unit 104 receives the specific signal S11 (step ST11) and determines whether or not the requested value of the received specific signal S11 conflicts with the control being executed (step ST12). In a case where it is determined that the requested value of the specific signal S11 does not conflict with the control being executed (step ST12; NO), the control unit 104 controls the motor 22 according to the specific signal S11 received in step ST11 (step ST13).

In a case where it is determined that the requested value of the specific signal S11 conflicts with the control being executed (step ST12; YES), the control unit 104 determines the priority of the requested value based on the priority map 114 (step ST14). The control unit 104 selects the requested value having a high priority (step ST15). The control unit 104 executes control in accordance with the selected requested value (step ST13).

In this manner, the specific signal S11 generated by the arbitration by the arbitration unit 102 is input to the control unit 104. The requested value included in the specific signal S11 is designated in advance. Based on the signals S1, S2, and S3, the arbitration unit 102 generates the specific signal S11 that includes a requested value conforming to provisions of the control unit 104, and an attribute of the requested value. Therefore, the control unit 104 may correspond to the requested value included in the specific signal S11.

FIG. 3 illustrates a steering angle control mode, a target steering angle, an additional torque, a torque upper limit, a vibration mode, and a vibration direction as requested values that can be included in the specific signal S11. In this example, the steering angle control mode, the target steering angle, the additional torque, and the torque upper limit are the requested values of ASIL-D or ASIL-B. In other words, the control unit 104 may have a function of controlling the motor 22 based on the requested values of the steering angle control mode, the target steering angle, the additional torque, the torque upper limit, the vibration mode, and the vibration direction. Furthermore, the control unit 104 may be able to distinguish between the requested values in five stages of ASIL-D, ASIL-C, ASIL-B, ASIL-A, and QM as the attributes of the requested values.

For example, in a case where the host control unit 200 is a device having a new function different from the functions listed above, the arbitration unit 102 may implement a function of generating the specific signal S11 based on a requested value output by the new device. In this case, new functions can be installed in the vehicle without changing the design of the control unit 104.

Another feature is that the specific signal S11 can include an additional torque. The additional torque refers to, for example, requested values of the SDA function, the road departure mitigation (RDM) function, and the motion adaptive function. Although the requested values of these functions can be set as steering angles of the electric power steering device 10, the requested values of steering angles may be requested values having high functional safety levels. On the other hand, the functional safety level of the additional torque for instructing the addition of steering angles can be set low on the premise of a hands-on state, particularly on the premise that the value of the torque added is limited to less than a certain value. Therefore, by enabling the control unit 104 to perform control corresponding to the requested value of the additional torque, the opportunity for the control device 100 to perform control with a high functional safety level can be reduced. In this configuration, for example, the host control unit 200 can realize the requested values of the straight driving assist (SDA) function, the road departure mitigation (RDM) function, and the motion adaptive function by converting the requested value of the steering angle to the requested value of the additional torque. Also, the arbitration unit 102 may be configured to convert the requested value of the steering angle to the requested value of the additional torque when generating the specific signal S11.

### 4. Other Embodiments

The foregoing embodiment shows a specific example to which the present invention is applied, and does not limit the aspects to which the invention is applied.

Although the foregoing embodiment has described the configuration in which the arbitration unit 102 executes arbitration of the signals S1, S2, and S3, the host control unit 200 may generate the signals S1, S2, and S3 after arbitrating, and transmit the signals S1, S2, and S3 to the control device 100. For example, in a case where the host control unit 200 transmits a requested value having a high functional safety level (for example, a requested value of ASIL-D) to the control device 100, the host control unit 200 may arbitrate the signals S1, S2, and S3 and transmit the arbitrated signals S1, S2, and S3 to the control device 100. In this case, the first host control unit 201, the second host control unit 202, and the third host control unit 203 may mutually execute communication through the CAN bus, and the control device 100 may receive the signals S1, S2, and S3 in the order and timing in which the signals S1, S2, and S3 are arbitrated. The host control unit 200 that executes processing having a high functional safety level has reliability corresponding to the high functional safety level. By executing the arbitration using such host control unit 200, the demand for reliability of the arbitration unit 102 can be alleviated, and thereby the control device 100 can be realized more easily.

The foregoing embodiment has described the configuration for controlling the electric power steering device 10 for steering the front wheels 20 of the vehicle, but this configuration is an example. The power steering device controlled by the present invention may be any device that maintains and changes the vehicle posture by steering the wheels. For example, the electric power steering device may be a device for steering four wheels including the front wheels 20 and the rear wheels of the vehicle, or may be a device for steering only the rear wheels.

The control device 100 may be configured to include one or a plurality of control devices in addition to the arbitration unit 102 and the control unit 104. The control device 100 may also be configured to control the electric power steering device 10 based on the detected values of other sensors in addition to the torque sensor 28 and the steering angle sensor 32. In addition, the control device 100 is not limited to a configuration including hardware corresponding to the arbitration unit 102 and the control unit 104, but may have a configuration that realizes the functions of the arbitration unit 102 and the control unit 104 by executing programs by means of the processor.

### 5. Configuration Supported by the Foregoing Embodiments

The foregoing embodiments are specific examples of the following configurations.

(Item 1) A control device controlling an electric power steering device that includes a motor generating a steering torque and applies a steering force to a steering mechanism of a vehicle, the control device including a control unit that receives a specific signal which indicates a requested value relating to an operation of the motor and which contains a specific type of requested value and an attribute of the requested value, and controls the motor based on the requested value indicated by the received specific signal.

According to the control device of the item 1, the control unit may be able to process the specific type of requested value. Thus, when adapting the control device to a new function involving steering of the vehicle, the design of the control unit controlling the motor does not need to be changed significantly. Therefore, the design man-hours associated with control of the electric power steering device can be reduced.

(Item 2) The control device according to the item 1, further including an arbitration unit that receives a request signal transmitted by a device outside the control device, wherein the arbitration unit generates the specific signal by arbitrating the request signal transmitted by the device outside the control device, and transmits the generated specific signal to the control unit.

According to the control device of the item 2, since the arbitration unit that arbitrates a request signal transmitted to the control device is provided in addition to the control unit for controlling the motor, the control unit may process the arbitrated specific signal. Therefore, in a case where, for example, a new function involving steering of the vehicle is added, a change in the design of the control unit can be minimized to small changes, and the design man-hours associated with control of the electric power steering device can be reduced.

(Item 3) The control device according to the item 2, wherein the control device receives the request signal that is arbitrated and transmitted by the device outside the control device.

According to the control device of the item 3, the control device can receive and process the arbitrated requested value. For example, in a case where the control device needs to arbitrate a request signal that includes a requested value having a high functional safety level, the control device requires high reliability. On the other hand, when the host control unit executing processing with a high functional safety level transmits the arbitrated request signal, the reliability requirement for the control device can be alleviated. Therefore, the design man-hours required for designing the control device can be reduced.

(Item 4) The control device according to any one of the items 1 to 3, wherein the control device includes priority designation information for defining a priority of the specific signal, and the control unit controls the motor based on the requested value indicated by the specific signal, in accordance with the priority defined by the priority designation information.

According to the control device of the item 4, the motor can be controlled based on the requested value indicated by the specific signal, without executing complicated arbitration processing.

(Item 5) The control device according to the item 4, wherein the priority designation information is information associating the attribute of the requested value indicated by the specific signal, with a priority of processing of the requested value indicated by the specific signal, and the control unit controls the motor based on the requested value indicated by the specific signal, in accordance with the priority defined by the priority designation information.

According to the control device of the item 5, the utilizing the attribute of the requested value, the priority of the requested value can easily be determined, and the motor can be controlled.

(Item 6) The control device according to the item 5, wherein the attribute of the requested value indicated by the specific signal includes at least one of a type of the requested value indicated by the specific signal and a functional safety level of the requested value indicated by the specific signal.

According to the control device of the item 6, based on the type and functional safety level of the requested value, the priority can be defined so as to keep the reliability required for steering the vehicle. Therefore, a design that satisfies the reliability required for steering can be realized with a small number of design man-hours.

(Item 7) The control device according to the item 5 or 6, wherein the attribute of the requested value indicated by the specific signal includes a functional safety level of the requested value indicated by the specific signal, and the priority designation information is information that is defined in such a manner that, for the specific signals having different functional safety levels, processing based on the specific signal having a higher functional safety level is executed preferentially, and, for the specific signals having an identical functional safety level, processing based on the specific signal having a larger requested value is executed preferentially.

According to the control device of the item 7, control based on the requested value with a higher functional safety level is executed preferentially. Therefore, a design that satisfies the reliability required for steering the vehicle can be realized with a small number of design man-hours.

(Item 8) The control device according to any one of the items 1 to 7, wherein the steering mechanism includes a steering handle, and the requested value included in the specific signal is a value indicating an additional torque added to an operation amount of the steering handle when the motor is operated according to the operation amount of the steering handle.

According to the control device of the item 8, since the motor can be controlled based on the requested value of the additional torque, the processing load in the control unit can be reduced.

(Item 9) A control method for controlling an electric power steering device that includes a motor generating a steering torque and applies a steering force to a steering mechanism of a vehicle, the control method including a step of inputting, to a control device controlling the motor, a specific signal which indicates a requested value relating to an operation of the motor and which contains a specific type of requested value and an attribute of the requested value, and a step of causing the control device to control the motor based on the requested value indicated by the specific signal.

According to the control method for controlling an electric power steering device according to the item 9, the control device controls the motor based on the specific type of requested value. Thus, when adapting the control device to a new function involving steering of the vehicle, the design associated with control of the motor does not need to be changed significantly. Therefore, the design man-hours associated with control of the electric power steering device can be reduced.

### REFERENCE SIGNS LIST

10 Electric power steering device
12 Steering handle
20 Front wheel
22 Motor
22a Output shaft
28 Torque sensor
32 Steering angle sensor
100 Control device
102 Arbitration unit
104 Control unit
112, 114 Priority map (priority designation information)
200 Host control unit
201 First host control unit
202 Second host control unit
203 Third host control unit
211 Driving assist device
212 Parking assist device
213 Occupant monitoring device
S1, S2, S3 Signal (request signal)
S11 Specific signal

What is claimed is:

1. A control device controlling an electric power steering device that includes a motor generating a steering torque and applies a steering force to a steering mechanism of a vehicle, the control device comprising
a control unit that receives a specific signal which indicates a requested value relating to an operation of the motor and which contains a specific type of requested value and an attribute of the requested value, and controls the motor based on the requested value indicated by the received specific signal.

2. The control device according to claim 1, further comprising
an arbitration unit that receives a request signal transmitted by a device outside the control device, wherein
the arbitration unit generates the specific signal by arbitrating the request signal transmitted by the device outside the control device, and transmits the generated specific signal to the control unit.

3. The control device according to claim 2, wherein the control device receives the request signal that is arbitrated and transmitted by the device outside the control device.

4. The control device according to claim 1, wherein the control device includes priority designation information for defining a priority of the specific signal, and
the control unit controls the motor based on the requested value indicated by the specific signal, in accordance with the priority defined by the priority designation information.

5. The control device according to claim 4, wherein
the priority designation information is information associating the attribute of the requested value indicated by the specific signal, with a priority of processing of the requested value indicated by the specific signal, and
the control unit controls the motor based on the requested value indicated by the specific signal, in accordance with the priority defined by the priority designation information.

6. The control device according to claim 5, wherein the attribute of the requested value indicated by the specific signal includes at least one of a type of the requested value indicated by the specific signal and a functional safety level of the requested value indicated by the specific signal.

7. The control device according to claim 5, wherein
the attribute of the requested value indicated by the specific signal includes a functional safety level of the requested value indicated by the specific signal, and
the priority designation information is information that is defined in such a manner that, for the specific signals having different functional safety levels, processing based on the specific signal having a higher functional safety level is executed preferentially, and, for the specific signals having an identical functional safety level, processing based on the specific signal having a larger requested value is executed preferentially.

8. The control device according to claim 1, wherein the steering mechanism includes a steering handle, and
the requested value included in the specific signal is a value indicating an additional torque added to an operation amount of the steering handle when the motor is operated according to the operation amount of the steering handle.

9. A control method for controlling an electric power steering device that includes a motor generating a steering torque and applies a steering force to a steering mechanism of a vehicle, the control method comprising:
a step of inputting, to a control device controlling the motor, a specific signal which indicates a requested value relating to an operation of the motor and which contains a specific type of requested value and an attribute of the requested value; and
a step of causing the control device to control the motor based on the requested value indicated by the specific signal.
